(19) United States
(12) Patent Application Publication
(10) Pub. No.: US 2016/0131803 A1
(43) Pub. Date: May 12, 2016

(54) LIGHT CONTROL SHEET

(71) Applicant: This and That Services, Inc., Grand Blanc, MI (US)

(72) Inventor: Terry W. Stanfill, Grand Blanc, MI (US)

(73) Assignee: THIS AND THAT SERVICES, INC., Grand Blanc, MI (US)

(21) Appl. No.: 14/939,481

(22) Filed: Nov. 12, 2015

Related U.S. Application Data
(60) Provisional application No. 62/078,493, filed on Nov. 12, 2014.

(51) Int. Cl. G02B 1/111

(52) U.S. Cl. CPC G02B 1/111

(57) ABSTRACT

Method and sheeted material is disclosed for controlling light to increase readability of tangible, non-digital printed reading material. The sheeted material of the invention includes an anti-glare semi-transparent sheet having at least one matte surface.

### CROSS REFERENCE TO RELATED APPLICATIONS

This application claims the benefit of U.S. Provisional Application No. 62/078,493 filed on Nov. 12, 2014 which is hereby incorporated herein by reference.

### TECHNICAL FIELD

This disclosure relates to reading, and more particularly to devices and methods for controlling light to increase readability of tangible, non-digital printed reading material.

### BACKGROUND

The statements in this section merely provide background information related to the present disclosure and may not constitute prior art.

Despite the invention and wide availability of electronic reading devices, tangible non-digital reading material, e.g., hard cover books, paperback books or magazines, remains popular and widespread. Occasionally, individuals may desire to read outside or other environment having exposure to sunlight or other glare inducing light source. Additionally, it is known for some reading materials to use paper having a highly reflective surface. It is not uncommon, therefore, for the pages of the reading material to reflect the incident light into the reader's eyes, causing a glare which makes the printed text difficult to read.

This glare causes undesirable eye strain and also lowers the contrast between the print and the paper, further making it difficult to read the printed material. The glare problem becomes significant when the reading materials are taken outdoors, since the sun is a single point of illumination and the pages of the reading materials can reflect a significant amount of sunlight into the eyes of the reader.

Therefore a need exists for a method and device to control the reflection of incident light into the eyes of the reader on printed materials.

### SUMMARY

A sheet is disclosed for controlling light to increase readability of tangible, non-digital printed reading material.

Certain embodiments of the invention include a feature of an anti-glare semi-transparent sheet comprising: an integral polypropolene material having at least one matte surface.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a light control sheet depicting glare reduction on a book, in accordance with the present disclosure;

FIG. 2 is a perspective view of the light control sheet, in accordance with the present disclosure;

FIG. 3 is a front view of an exemplary light control sheet, in accordance with the present disclosure;

FIG. 4 is a side view of the exemplary light control sheet as seen from a top side of FIG. 3, in accordance with the present disclosure; and

FIG. 5 is a side view of the exemplary light control sheet as seen from a left side of FIG. 3, in accordance with the present disclosure; and

FIG. 6 is a cross-sectional view of an exemplary light control sheet taken along line A-A, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

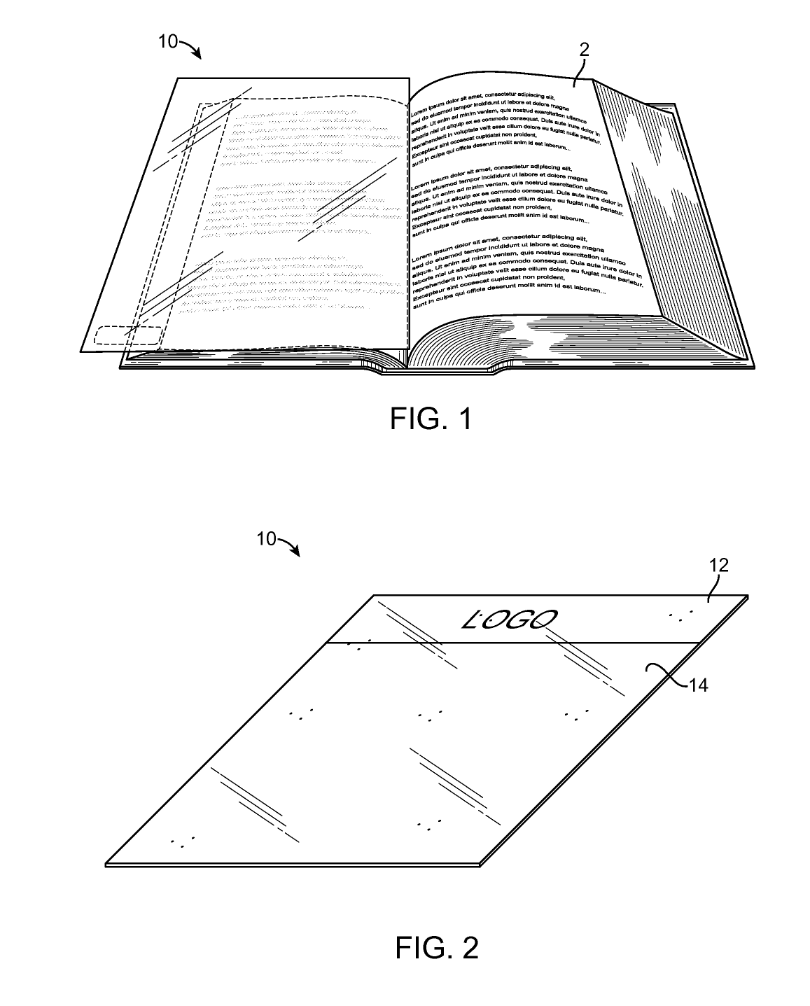

Referring now to the drawings, wherein the depictions are for the purpose of illustrating certain exemplary embodiments only and not for the purpose of limiting the same, FIG. 1 schematically shows an exemplary light control sheet 10 in use over a page of a book 2.

The light control sheet 10 is formed of a semi-transparent material. In one embodiment, the light control sheet 10 is polymer-based, for example polypropholene. The light control sheet 10 may be substantially transmissive of light within a desired range of wavelengths, or spectral range, such as the visible spectrum or portion thereof. In one embodiment, the light control sheet 10 is formed of a single, integral layer of material.

In one embodiment, the light control sheet 10 is formed of more than one layer, e.g., a light wavelength filter and a light polarization filter. In various embodiments, the multiple layers may be bonded by use of an optically clear adhesive. Bonding methods including direct lamination, ultrasonic welding, and other suitable techniques are also contemplated. In exemplary embodiments, the multiple layers are made of substantially semi-transparent materials, and are made of the same material(s) or are made of materials that have the same or nearly the same index of refraction. Likewise, if an optical adhesive or other such material is disposed between layers to bond the films together, the material disposed between the films is preferably index matched (or nearly so) to the material(s). Matching or nearly matching indices of refraction can help to reduce reflections at the interfaces between materials, and thereby increase the overall transmission of the light control sheet 10.

In one embodiment, the light control sheet 10 includes material having a plurality of light absorbing regions. Light absorbing regions can have any suitable shape, geometry, and dimensions, and generally extend into the material from one surface of the sheet. The light absorbing regions may be rendered light absorbing by filling the regions with a light absorbing material or coating the walls of the regions with a light absorbing material, for example as known in the art. The light absorbing regions can also be formed by filling the regions or coating the walls of the regions with a light scattering or dispersing material. As such, the term “light absorbing” as used in this document to refer to regions in the light control sheet 10 that are intended to substantially block the transmission of light within a desired spectral range can include materials that primarily function to absorb light and/or materials that primarily function to scatter (or disperse) light.

Light absorbing materials can be any suitable material, such as one that functions to absorb or block light at least in a portion of the visible spectrum. In some embodiments, the light absorbing material can be coated or otherwise provided in grooves or indentations in the sheet to form light absorbing regions.

In further embodiments, light absorbing materials can include a black colorant, such as carbon black. The carbon black may be a particulate carbon black having a particle size less than 10 microns, for example 1 micron or less. The carbon black may, in some embodiments, have a mean particle size of less than 1 micron. In yet further embodiments, the absorbing material, (e.g., carbon black, another pigment or dye, or combinations thereof) can be dispersed in a suitable binder. Light absorbing materials also include particles or other scattering elements that can function to block light from being transmitted through the light absorbing regions.

As shown in FIG. 1, the light control sheet 10 can be placed proximate a book 2 or other reading material. In various embodiments including a privacy filter, at normal incidence (or 0° viewing angle) where a viewer is looking at an image through the light control sheet 10 in a direction that is perpendicular to the light control sheet 10, the book is viewable, and the fraction of light reflected from the book that is transmitted though the light control sheet 10 is controlled for a predetermined range. As the viewing angle increases, the amount of light transmitted through the light control sheet 10 from the book to the reader decreases until a maximum viewing angle is reached where substantially all the light is blocked by the light absorbing elements and the book is no longer readable. This can provide privacy to a reader by blocking observation by others that are outside a typical range of viewing angles contemplated for use or viewing of the book or reading material.

In various privacy filter embodiments, it may be desirable for the light control sheet 10 to exhibit a relatively high transmission over a range of viewing angles that includes normal incidence, and to exhibit a transmission that falls off relatively rapidly to zero, or nearly so, for viewing angles outside the high transmission range. Such behavior of transmission versus viewing angle allows direct viewers to view a book through the light control sheet 10 with sufficient brightness throughout a selected range of viewing angles while blocking the view of onlookers. Thus, the light control sheet 10 can act as a privacy filter.

The light control sheet 10 of the present invention can provide many advantages. For example, higher aspect ratio absorbing elements can be made while maintaining relative ease of manufacturability and a large range of possible light absorbing element geometries. This can lead to a light control sheets 10 that have high transmission over a desired range of viewing angles, and a sharp cutoff in transmission for viewing angles outside of the desired range.

The light control sheet 10 may be composed of polypropylene (PP) polyethylene terephthalate (PET) and/or polycarbonate (PC). Other suitable substrate materials may include polyethylene naphthalate (PEN), polybutylene terephthalate (PBT), polymethyl methacrylate (PMMA), polystyrene (PS), polyetherimide (PEI), polyethylene (PE), low-density polyethylene (LDPE), linear low-density polyethylene (LLDPE), ethylene-octene copolymer (EO), ethylene-styrene copolymer (ES), ethylene-propylene copolymer (EP), ethylene-hexene copolymer (EH), acrylonitrile butadiene styrene (ABS), tetrafluoroethylene-hexafluoropropylene-vinylidene fluoride copolymer (THV), polyurethane (PU), polyvinyl alcohol (PVA), ethylene vinyl acetetate (EVA), ethyelene-co-acrylate acid (EAA), polyamide (PA), polyvinyl chloride (PVC), polydimethylsiloxane (PDMS), poly p-phenylene sulfide (PPS), polyvinylidene fluoride (PVDF), polyether sulfone (PES) and their copolymers and blends, or glass, or other transparent substrate with visible light transmission of 50% or more.

The light control sheet 10 includes an integral matte layer on a major surface. In various embodiments, the matte layer is present on the exposed viewing surface layer.

The presence of the matte (e.g. surface) layer advantageously provides a reduction in glare, i.e. antiglare properties. The presence of the matte surface layer can also improve the durability of the film by increasing the pencil hardness or increasing the steel wool durability. In some embodiments, inclusion of the matte (e.g. micro structured) layer can improve on-axis luminance. For embodiments wherein the matte (e.g. microstructured) layer differs in refractive index, the inclusion of the matte layer can reduce the specular reflections.

In one embodiment, the matte layer is formed from a coatings applied to the light control sheet 10. Matte coatings may be suitably sized (e.g. inorganic oxide or organic such as polystyrene) particles in a coating composition. Matte particles typically have an average size that is greater than about 0.25 micron (250 nanometers), or greater than about 0.5 micron, or greater than about 0.75 micron, or greater than about 1 micron, or greater than about 1.25 microns, or greater than about 1.5 microns, or greater than about 1.75 microns, or greater than about 2 microns. In various embodiments, matte particles typically have an average particle size no greater than 10 microns. The concentration of matte particles may range from at least 1 or 2 wt-% to about 5, 6, 7, 8, 9, or 10 wt-% or greater in various embodiments.

Alternatively, or in addition thereto, the surface can be roughened or textured to provide a matte surface. This can be accomplished in a variety of ways as known in the art including embossing a low refractive index surface together with the underlying layer(s) with a suitable tool that has been bead-blasted or otherwise roughened.

In various embodiments, a microstructured matte surface layer is used wherein microstructures are generally fabricated using microreplication from a tool by casting and curing a polymerizable resin composition in contact with a tool surface. The tool may be fabricated using any available fabrication method, such as by using engraving or diamond turning. Exemplary diamond turning systems and methods can include and utilize a fast tool servo.

Durable matte layers may include a relatively thick microstructured matte (e.g. viewing) surface layer. The microstructured matte layer typically has an average thickness (“t”) of at least 0.5 micron, preferably at least 1 micron, and more preferably at least 2 or 3 microns. The microstructured matte layer typically has a thickness of no greater than 15 microns and more typically no greater than 4 or 5 microns. However, when durability of the matte film is not required, the thickness of the microstructured matte layer can be thinner In some embodiments, the microstructures are substantially free of (e.g. inorganic oxide or polystyrene) matte particles. However, even in the absence of matte particles, the microstructures typically comprise (e.g. silica) nanoparticles.

The size of the nanoparticles may be selected to avoid significant visible light scattering. It may be desirable to employ a mixture of inorganic oxide particle types to optimize an optical or material property and to lower total composition cost. The surface modified colloidal nanoparticles can be inorganic oxide particles having a (e.g. unassociated) primary particle size or associated particle size of at least 1 nm or 5 nm. The primary or associated particle size is generally less than 100 nm, 75 nm, or 50 nm. Typically the primary or associated particle size is less than 40 nm, 30 nm, or 20 nm. It is preferred that the nanoparticles are unassociated. Their measurements can be based on transmission electron microscopy. Surface modified colloidal nanoparticles can be substantially fully condensed. Due to the substantially smaller size of nanoparticles, such nanoparticles do not form a microstructure. Rather, the microstructures comprise a plurality of nanoparticles.

In other embodiments, a portion of the microstructures may comprise embedded matte particles. Smaller matte particles are typical for matte layers that comprise a relatively thin microstructured layer. However, for embodiments wherein the microstructured layer is thicker, the matte particles may have an average size up to 5 microns or 10 microns.

It is surmised that the presence of (e.g. silica or CaCO3) matte particles may provide improved durability even when the presence of such matte particles is insufficient to provide the desired matte (e.g. clarity and haze) properties as will subsequently be described. However, due to the relatively large size of matte particles, it can be difficult to maintain matte particles uniformly dispersed in a coating composition. This can cause variations in the concentration of matte particles applied (particularly in the case of web coating), which in turn causes variations in the matte properties.

For embodiments wherein at least a portion of the microstructures comprise an embedded matte particle or agglomerated matte particle, the average size of the matte particles is typically sufficiently less than the average size of microstructures (e.g. by a factor of about 2 or more) such that the matte particle is surrounded by the polymerizable resin composition of the microstructured layer.

The plurality of peaks of the microstructured surface can also be characterized with respect to mean height, average roughness (Ra), and average maximum surface height (Rz). The average surface roughness (i.e. Ra) may be less than 0.20 micron. The average maximum surface height (i.e. Rz) may be less than 3 microns or less than 2.5 microns. In various embodiments having high clarity in combination with sufficient haze, exhibit an Rz of less no greater than 1.20 microns. In some embodiments, the Rz is less than 1.10 or 1.00 or 0.90, or 0.80 microns. The Rz is typically at least 0.40 or 0.50 micron.

In various embodiments, the microstructured layer may include a polymeric material such as the reaction product of a polymerizable resin. The polymerizable resin may include surface modified nanoparticles. A variety of free-radically polymerizable monomers, oligomers, polymers, and mixtures thereof can be employed in the polymerizable resin, such as those employed in convention “hardcoat” coating compositions. The concentration of (e.g. inorganic) nanoparticles in the microstructured matte layer is typically at least 25 wt-% or 30 wt-%. The moderate refractive index layer typically comprises no greater than 50 wt-% or 40 wt-% inorganic oxide nanoparticles.

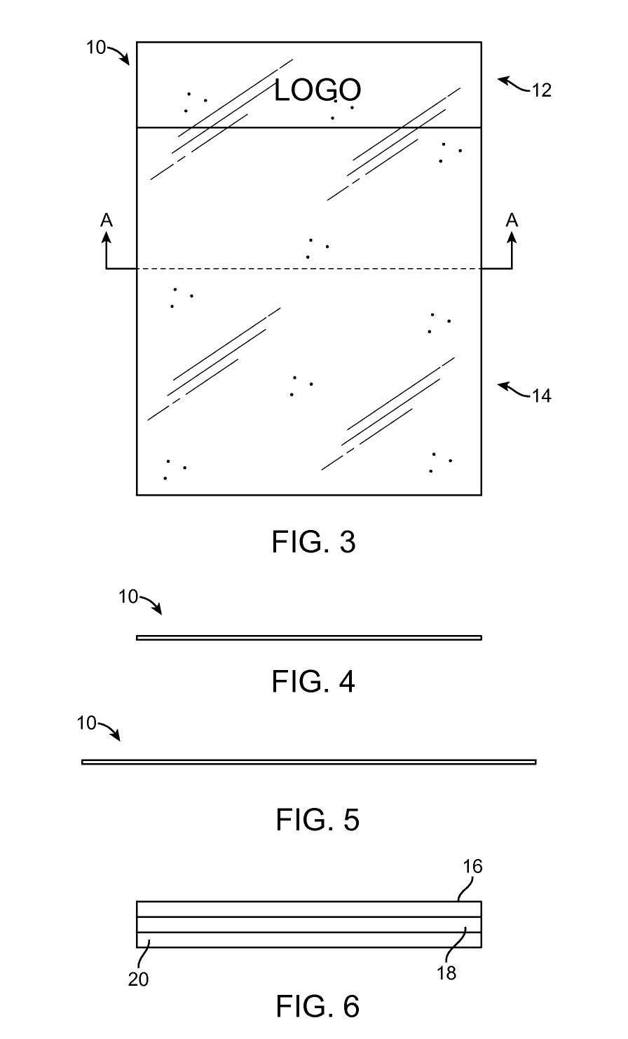

FIGS. 2-3 show an exemplary embodiment of the sheet 10 having a first and second section 12 and 14, respectively. In various embodiments, the first and second sections 12 and 14 may have matte surfaces corresponding to differing transparency levels. For example, the first section 12 may have a matte surface associated with a near opaque light transmissive state, while the second section 14 may have a matte surface associated with a second transparency level.

FIG. 6 shows a cross-sectional view of the sheet 10 along line A-A of FIG. 3. As FIG. 6 shows, the sheet 10 may be comprised of a top and bottom matte surfaces 16 and 20, respectively. The matte surfaces 16 and 20 may be integral with the sheet material 18, in various embodiments. In one embodiment, one of the one of the surfaces 16 or 20 comprise a matte surface, while the other does not.

The disclosure has described certain embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. An anti-glare sheet comprising:
an integral polypropylene material having a matte surface on at least one surface, wherein the sheet is semi-transparent.

2. The sheet of claim 1, wherein the sheet includes a first region having a matte surface configured to permit a first threshold of transparency and a second region having a matte surface configured to permit a second threshold of transparency.

3. The sheet of claim 2, wherein the first region is opaque.

4. The sheet of claim 1, wherein the sheet is configured as a privacy filter.

5. An anti-glare sheet comprising:
a semi-rigid polypropylene material having a planar shape, wherein the sheet is semi-transparent; and
a matte surface configured to reduce light glare.

6. The sheet of claim 5, wherein the sheet includes a plurality of regions each having a unique threshold of transparency.

7. The sheet of claim 5, wherein the sheet includes a first region having a matte surface configured to permit a first threshold of transparency and a second region having a matte surface configured to permit a second threshold of transparency.

8. The sheet of claim 7, wherein the first region and second regions comprise an entire upper surface of the sheet.

9. The sheet of claim 8, wherein the first region is rectangular-shaped and extends from a first side of the sheet to a second side of the sheet and from a top end to a predefined boundary extending from the first side of the sheet to the second side of the sheet.

10. The sheet of claim 9, wherein the first region is opaque.

11. The sheet of claim 5, wherein the sheet is configured as a privacy filter.

12. An anti-glare sheet comprising:
a semi-rigid polypropylene material having a planar shape, wherein the sheet is semi-transparent; and
wherein the sheet further comprises a top and bottom matte surface configured to reduce light glare having a plurality of regions each having a unique threshold of transparency.

13. The sheet of claim 12, wherein the sheet includes a first region and a second region that together form an entire top surface of the sheet.

14. The sheet of claim 13, wherein the first region comprises a matte surface configured to permit a first threshold of transparency and a second region having a matte surface configured to permit a second threshold of transparency.

15. The sheet of claim 14, wherein the first region is rectangular-shaped and extends from a first side of the sheet to a second side of the sheet and from a top end to a predefined boundary extending from the first side of the sheet to the second side of the sheet.

16. The sheet of claim 14, wherein a maximum surface height of the matte surface is at least 0.50 microns.

17. The sheet of claim 15, wherein the matte surface is formed using microstructures, wherein at least a portion of the microstructures comprise an embedded matte particle.

18. The sheet of claim 17, wherein the microstructures are generally fabricated using microreplication.

19. The sheet of claim 18, wherein the matte surface has an average thickness of between 2 and 3 microns.

20. The sheet of claim 17, wherein the top and bottom matte surfaces are formed from microstructures comprising a plurality of embedded silica nanoparticles
